(19) United States
(12) Patent Application Publication
(10) Pub. No.: US 2022/0134589 A1
(43) Pub. Date: May 5, 2022

(54) PARTIALLY-SERRATED DISPOSABLE PIZZA CUTTER

(71) Applicant: Samuel Spadoni, Darien, IL (US)

(72) Inventor: Samuel Spadoni, Darien, IL (US)

(21) Appl. No.: 17/090,873

(22) Filed: Nov. 5, 2020

(51) Int. Cl. B26B 25/00

(52) U.S. Cl. CPC B26B 25/005

(57) ABSTRACT

This invention is a partially-serrated disposal pizza cutting apparatus. The invention is an affordable, safe, easy-to-use, single body cutting device with a graspable handle joined at a static contact point to a round cutting portion having a circumference that has both serrated and non-serrated segments to slice and separate customized pizza portions.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LIST COMPACT DISC APPENDIX

Not applicable.

### BACKGROUND OF THE INVENTION

Whether prepared at home or by a third-party, the last step prior to enjoying a favorite pizza is always the same: divvying up the warm dish into desired slice portions. Pizza cutting devices typically are a metal wheel with a razor sharp, rotating cutting blade. Moreover, the handle portion of these cutting devices is usually made of a different material than the blade, making them bulky and expensive.

While restaurants often provide take-out and delivery customers with disposable forks, knives, spoons, plates, and napkins, one is usually required to find a utensil at home to slice an uncut pizza into desired proportions.

This novel pizza cutter addresses all these issues and more. It is a solitary body, easy-to-transport device with a static, partially-serrated cutting portion that can easily be rinsed off for future use or tossed in the garbage after single use. Whereas current pizza cutters feature a rotating cutting wheel blade made of sharp steel, the cutting portion of the current invention is static, plastic, and partially-serrated.

The duel nature of the circumference of the round cutting member serves multiple purposes as its serrated segment allows for ease of slicing through thicker crusts and heavy topping pizzas, while the non-serrated segment allows a user to finish off the lingering cheese strings.

This cutting device is sleek and made of plastic, strong enough to cut through the thickest of crusts while also being safe and sanitary. The instant availability of a reliable, disposable, safe, sanitary cutting device, with a cutting edge that combines both serrated and smooth portions is highly desirable to hungry consumers. The user can easily rinse it off after use, or simply toss it in the trash during quick cleanup.

The size, shape, material, and static nature of the cutting portion of the device allows for simple, on-the-go transport to enhance enjoyment of one's favorite pizza away from home, whether picnicking at the local park or tailgating in the stadium parking. These dining experiences are greatly enriched by the ability to easily divvy-up customized slices, followed by quick, efficient clean-up.

This single-use, disposable, cutting device serves not only its utility purpose, but also offers a safe, sanitary, one-use option for those conscious of germs. When done using, you can either toss it in the garbage, or simply rinse it off and easily store the same for future use. With this invention, custom pizza slicing and cleaning up after eating on-the-go is simplified. The partially-serrated disposable pizza truly enhances any culinary experience.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### BRIEF SUMMARY OF THE INVENTION

This invention is a partially-serrated disposable pizza cutting device that allows for quick, efficient, safe, sanitary, and affordable slicing of a cooked pizza into desired slices for optimal enjoyment.

Namely, this cutting device comprises:
a graspable handle portion and a cutting member portion joined at a static contact point;
the graspable handle portion has a smooth arched upper side, a lower side with concave inlets to receive the fingers of the user, a rounded blunt handle end, and a flared T-shaped end having a top part and a bottom part;
the top part of the flared T-shaped end is adapted to receive the thumb of the user;
the cutting member portion is round with a segment of its circumference serrated.

The user grasps the cutting device at the handle portion, wrapping fingers around the handle portion, allowing fingers to engage the handle portion at the concave inlets on the lower side of the handle portion, and thumb to rest against the top part of the flared T-shaped end. User then selects an entry point of a pizza to slice into, preferably along the outer perimeter, inserting the serrated portion of the cutting member portion into the pizza at said point, applying downward and forward pressure at the same time moving the cutting device across the pizza in a straight line from one end to the other, then changing direction and pulling the device back towards the user while applying downward pressure, lifting the cutting device away from the pizza once reaching the initial entry point. The user then selects another entry point on the pizza to repeat the same steps based on the desired number, size, and shape of pizza slices.

In its preferred embodiment, the partially-serrated disposable pizza cutter is made from high density polyethylene. However, one skilled in the art will recognize that partially-serrated disposable pizza cutters made from a number of non-pliable thermal plastic polymers may be anticipated. The graspable handle portion is uniformly thicker than the partially-serrated round cutting portion.

The partially-serrated disposable pizza cutter is known to be compatible with thin, thick, and deep dish style pizzas. Furthermore, it can be used with any shape or style of pizza. While the serrated part of the round cutting portion is used to cut through the pizza itself, one can use the smooth part of the round cutting portion to cut residual excess cheese or other toppings after the slice of pizza is formed.

When done using, the partially-serrated disposable pizza cutter can be either tossed in the garbage or easily rinsed clean for later use.

### BRIEF DESCRIPTION OF THE SEVERAL VIEWS OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

FIG. 1 depicts an angled front view of the partially-serrated disposable pizza cutter.

FIG. 2 depicts the partially-serrated disposable pizza cutter from a straight front view in an upright position, and also depicts the measured difference between the serrated and non-serrated segments of the circumference of the round cutting portion.

FIG. 3 depicts a view of the partially-serrated disposable pizza cutter laid on its side with the smooth arched upper side of the graspable handle portion and the non-serrated segment of the circumference of the round cutting portion facing forward.

FIG. 4 depicts the partially-serrated disposable pizza cutter from a straight front view.

FIG. 5 depicts a view of the partially-serrated disposable pizza cutter laid on its side with the lower side of the graspable handle portion with concave inlets and the serrated segment of the circumference of the cutting portion facing forward.

FIG. 6 depicts a view of the partially-serrated disposable pizza cutter looking from the blunt rounded handle end towards the cutting portion when in an upright position.

FIG. 7 depicts a view of the partially-serrated disposable pizza cutter looking from the cutting portion towards the rounded bunt handle end when in an upright position.

FIG. 8 depicts the partially-serrated disposable pizza cutter in the hand of a user engaged in the act of cutting a slice of pizza.

FIG. 9 depicts a view from the side of the pizza, the front half of the pizza removed, with the partially-serrated disposable pizza cutter engaged in the act of cutting a slice of pizza.

### DETAILED DESCRIPTION OF THE INVENTION

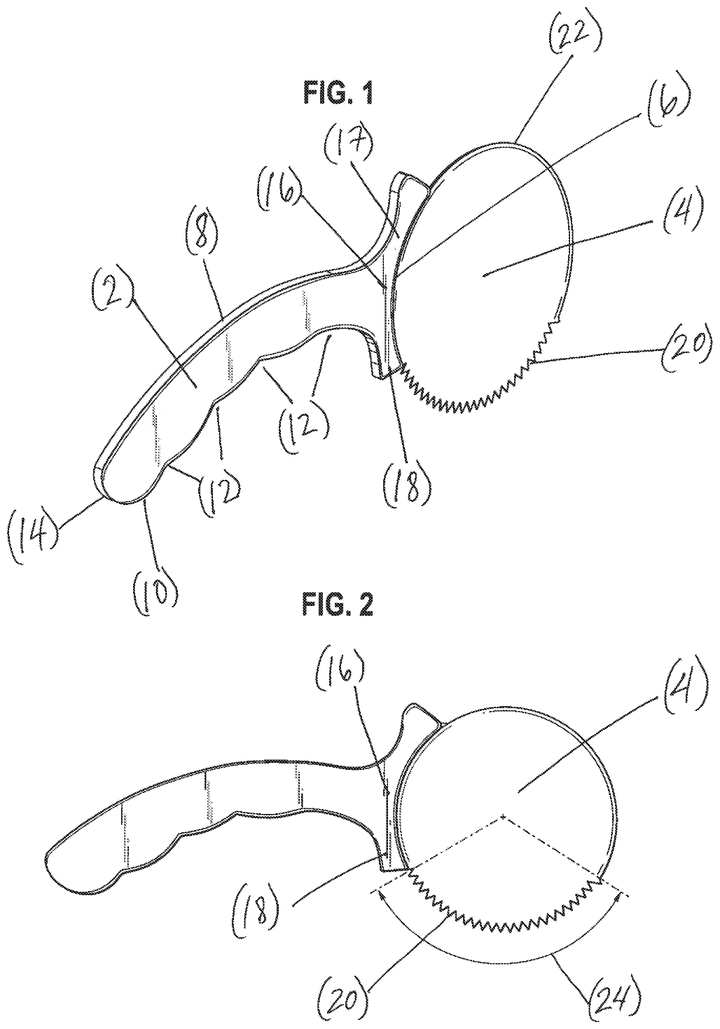

Turning now to the figures, FIG. 1 depicts the partially-serrated disposable pizza cutter from an angled front view to showcase its features and dimensions. The pizza cutter consists of a graspable handle portion (2) and a cutting member portion (4). The graspable handle portion (2) and the cutting member portion (4) are joined at a static contact point (6). The graspable handle portion (2) has a smooth arched upper side (8), a lower side (10) with concave inlets (12) to receive the fingers of the user, a blunt rounded handle end (14), and a flared T-shaped end (16) with a top part (17) and a bottom part (18). Along the flared T-shaped end (16) is where the graspable handle portion (2) meets the cutting member portion (4) at the static contact point (6). The top part (17) of the flared T-shaped end (16) is adapted to receive the thumb of the hand of the user. The graspable handle portion (2) is uniform in its thickness and is proportionately thicker than the cutting member portion (4), which is rounded in shape and uniform in its thickness. The circumference of the cutting member (4) has a serrated segment (20) and a non-serrated segment (22). The serrated segment (20) of the circumference of the cutting member portion (4) starts adjacent to the bottom part (18) of the flared T-shaped end (16) and extends outward from the graspable handle portion (2) a fixed distance along the circumference of the cutting member portion (4).

FIG. 2 depicts the partially-serrated disposable pizza cutter from a straight front view in an upright position. The serrated segment (20) of the circumference of the cutting member portion (4) starts adjacent to the bottom part (18) of the flared T-shaped end (16) and extends outward from the graspable handle portion (2) a fixed distance (24) along the circumference of the cutting member portion (4).

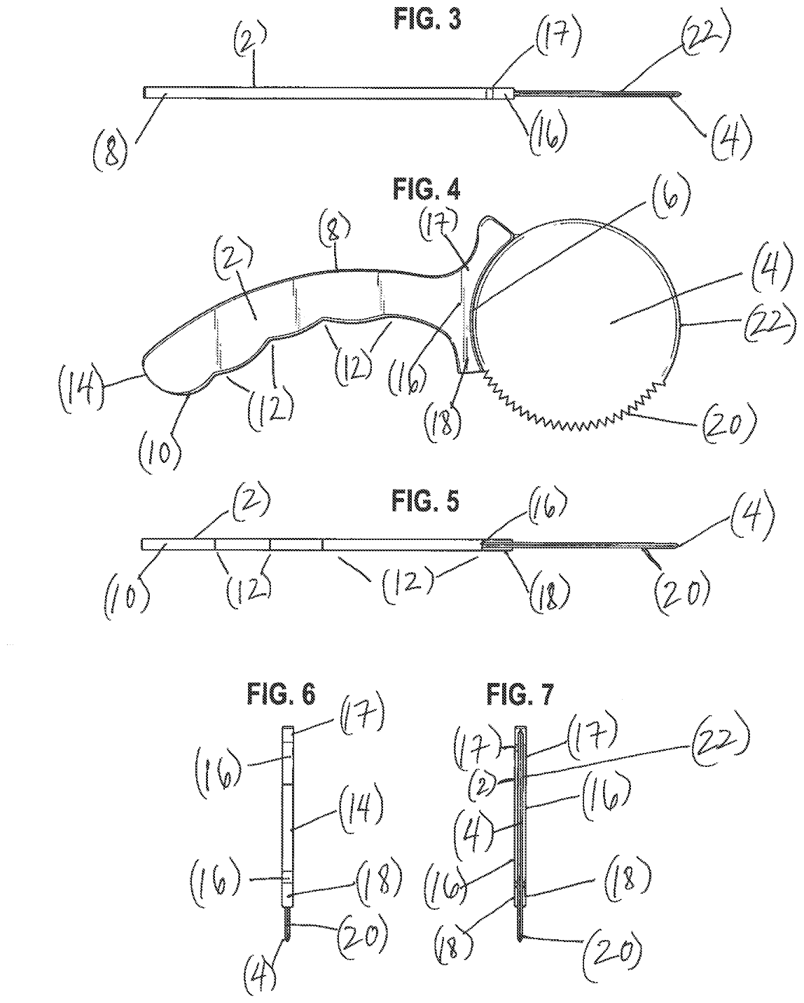

FIG. 3 depicts a view of the partially-serrated disposable pizza cutter laid on its side with the smooth arched upper side (8) of the graspable handle portion (2) and the non-serrated segment (22) of the circumference of the cutting member portion (4) facing forward. The top part (17) of the flared T-shaped end (16) is depicted as well.

FIG. 4 depicts the partially-serrated disposable pizza cutter from a straight front view. The graspable handle portion (2) and the cutting member portion (4) are joined at a static contact point (6). The graspable handle portion (2) has a smooth arched upper side (8), a lower side (10) with concave inlets (12) to receive the fingers of the user, a blunt rounded handle end (14), and a flared T-shaped end (16) with a top part (17) and a bottom part (18). The cutting member portion (4) is round in shape with a circumference having a serrated segment (20) and a non-serrated segment (22).

FIG. 5 depicts a view of the partially-serrated disposable pizza cutter laid on its side with the lower side (10) of the graspable handle portion (2) with concave inlets (12) and the serrated segment (20) of the circumference of the cutting member portion (4) facing forward. The bottom part (18) of the flared T-shaped end (16) is depicted as well.

FIG. 6 depicts a view of the partially-serrated disposable pizza cutter looking from the blunt rounded handle end (14) towards the cutting member portion (4) when in an upright position such that the top part (17) and the bottom part (18) of the flared T-shaped end (16) and a small portion of the serrated segment (20) of the circumference of the cutting member portion (4) are also visible as the graspable handle portion (2) is uniformly thicker than the cutting member portion (4).

FIG. 7 depicts a view of the partially-serrated disposable pizza cutter looking from the cutting portion (4) towards the blunt rounded handle end (14) when in an upright position such that the top part (17) and the bottom part (18) of the flared T-shaped end (16) and the serrated segment (20) and non-serrated segment (22) of the circumference of the cutting member portion (4) are also visible as the graspable handle portion (2) is uniformly thicker than the cutting member portion (4).

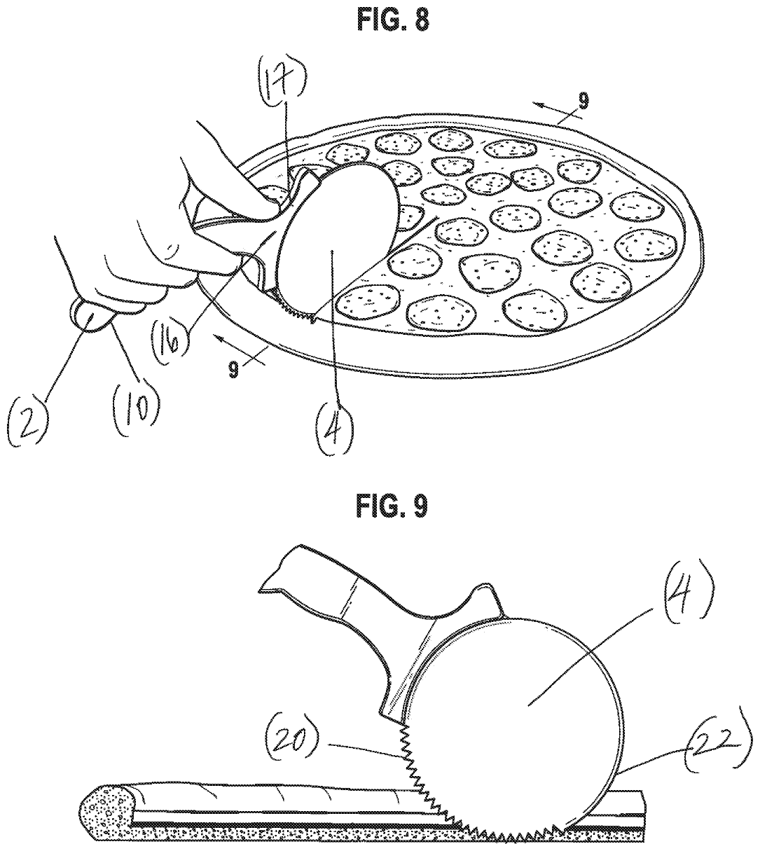

FIG. 8 depicts the partially-serrated disposable pizza cutter in the hand of a user engaged in the act of cutting a slice of pizza. The user is depicted holding the graspable handle portion (2) of the partially-serrated disposable pizza cutter, the fingers engaged in the concave inlets on the lower side (10) and the thumb received by the top part (17) of the flared T-shaped end (16). The cutting portion (4) is engaged with the pizza.

FIG. 9 depicts a view from the side of the pizza, the front half of the pizza from FIG. 8 removed, with the partially-serrated disposable pizza cutter engaged in the act of cutting a slice of pizza, showing the cutting member portion (4) engaged with the pizza at both the serrated (20) and non-serrated (22) segments of the circumference of the cutting portion (4).

While the figures depict a handle sized for an average adult and the circumference of the cutting member being 25% serrated, one skilled in the art will recognize that multiple versions of each are anticipated.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

What is claimed is:

1. A cutting device comprising:
a graspable handle portion and a cutting member portion joined at a static contact point.

2. The cutting device of claim 1, wherein the graspable handle portion has a smooth curved upper side, a lower side with concave inlets to receive the fingers of a user, a rounded blunt handle end, and a splayed end having a top part and a bottom part.

3. The cutting device of claim 2, wherein the top part of the splayed end is adapted to receive the thumb of a user.

4. The cutting device of claim 2, wherein the cutting member portion is rounded in shape further comprising an outside edge having a fixed portion which is serrated.

5. The cutting device of claim 4, wherein the fixed serrated portion begins adjacent to the bottom part of the splayed end and extends outward from the graspable handle portion a fixed distance along the circumference of the cutting member portion.

6. The method of using a cutting device comprising:
a graspable handle portion having a smooth curved upper side, a lower side with concave inlets to receive the fingers of a user, a rounded blunt handle end, and a splayed end having a top part and a bottom part and a cutting member portion which is rounded in shape further comprising a circumference having a serrated segment joined at a static contact point comprising the steps of:
grasping the cutting device at the handle portion with a user's hand, wrapping fingers around the handle portion, allowing fingers to engage the handle portion at the concave inlets on the lower side of the handle portion, and thumb to rest against the top part of the splayed end, selecting a starting point of a pizza to slice into, preferably along the outer perimeter, inserting the serrated portion of the cutting member portion into the pizza at said point, applying downward and forward pressure at the same time moving the cutting device across the pizza in a straight line from one end to the other, then reversing direction and pulling the cutting device back towards the starting point while applying downward pressure, lifting the cutting device away from the pizza when reaching the starting point, and selecting another point to repeat the same steps based on the desired size and shape of pizza slices.

7. The method of claim 6, wherein the graspable handle portion has a smooth curved upper side, a lower side with concave inlets to receive the fingers of a user, a rounded blunt end, and a splayed end with a top part and a bottom part.

8. The method of claim 7, wherein the top part of the splayed end is adapted to receive the thumb of a user.

9. (canceled)

10. The method of claim 8, wherein the serrated segment begins adjacent to the bottom part of the splayed end and extends outward from the graspable handle portion a fixed distance along the circumference of the cutting member portion.
